(19) United States
(12) Patent Application Publication
(10) Pub. No.: US 2004/0196796 A1
(43) Pub. Date: Oct. 7, 2004

(54) Registrations in a communication system

(76) Inventors: Gabor Bajko, Budapest (HU); Gabor Jaro, Budapest (HU); Jozsef Varga, Nagydobsza (HU)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/632,088

(22) Filed: Aug. 1, 2003

(30) Foreign Application Priority Data
Apr. 4, 2003 (GB) 0307853.2

(51) Int. Cl. H04B 7/00

(52) U.S. Cl. 370/310

(57) ABSTRACT

A communication system and a method wherein a subscription can be associated with a plurality of public and private identities are provided. According to one embodiment, the method includes the steps of storing in a user information storage information of the relations between the identities and of a control entity in which at least one of the public and private identities is registered, and allocating the control entity to a further registration based on the information stored in the user information storage.

### BACKGROUND OF THE INVENTION

1. Field of the Invention

The invention relates to a communication system, and in particular to a communication system wherein a subscription is allowed to have multiple registrations to control aspects of the system.

2. Description of the Related Art

A communication system can be seen as a facility that enables communication between two or more entities such as user equipment and/or other nodes associated with the system. The communication may include, for example, communication of voice, data, multimedia and so on.

A communication system typically operates in accordance with a given standard or specification which sets out what the various elements of the system are permitted to do and how that should be achieved. For example, the standard or specification may define if the user, or more precisely, user equipment or terminal is provided with a circuit switched service and/or a packet switched service. Communication protocols and/or parameters which shall be used for the connection may also be defined. In other words, a specific set of “rules” on which the communication can be based on needs to be defined to enable communication by means of the system.

Communication systems proving wireless communication for user equipment or other types of terminating nodes are known. An example of the wireless systems is a cellular network. In cellular systems, a base transceiver station (BTS) or similar access entity serves user equipment (UE) via a wireless interface between these entities. The mobile user equipment is typically referenced by the term mobile station (MS). Communications in the system can be controlled by one or several control entities. The various control entities may be interconnected. One or more gateway nodes may also be provided for connecting the cellular network to other networks, such as to another cellular system or to a public switched telephone network (PSTN) and/or other communication networks such as an IP (Internet Protocol) and/or other packet switched networks. The communication between the user equipment and the entities of the communication network can be based on an appropriate communication protocol. An example of the protocols is the session initiation protocol (SIP).

The communication systems have developed in the direction wherein various service provision functions of the network are handled by network entities known as servers. For example, in the current third generation (3G) wireless multimedia network architectures it is assumed that several different servers are used for handling different functions. These include functions such as the call state control functions (CSCFs). The call state control functions may be divided into various categories such as a proxy call state control function (P-CSCF), interrogating call state control function (I-CSCF), and serving call state control function (S-CSCF). It shall be appreciated that sometimes the CSCFs may be referenced to as the call session control functions.

The serving call state control function forms the entity the subscriber needs to be registered at in order to be able to request for a service from the communication system. In addition to the serving control entity, the user may need to be associated with proxy and interrogating control entities.

A user may have more than one registration at the same time. At least one registration is required for the user to be able to communicate via the communication system. During registration proceedings various authentication queries or messages and authentication parameters such as those based on authentication quintets and/or keys may need to be transferred between the entities involved in the process.

Typically a registration means that a user registers an identity at the serving call state control function. During the registration procedure an identity such as a public identity (ID) is provided for the controller entity. The public ID is an identity that associates with the subscription to the communication system. The public identity may function as a telephone number of the known telephone systems. However, while a conventional telephone such as a 2^{nd} generation (2G) mobile phone can only have one number, e.g. a 3G phone may have more than one identity (e.g. a telephone number, one or more email-like addresses, for example session initiation protocol (SIP) universal resource locators (URL), an address or addresses for alternative communications means, and so on).

A subscription may also have at least one associated private identity. The private identity may refer to a particular user of a subscription. That is, a subscription may have more than one user. The user, may be seen as logically equaling an identity entity such as any appropriate subscriber identity module (SIM).

A subscription may associate with various identities and users. For example, it is possible that a family or organization (such as a an office) has a common public identity. In addition to that, all members of the group may have further public identities and private identities.

In the 3G communication systems a user who wants to initiate a call or receive a call the user must register his/hers public ID. If a user has two public IDs (e.g. ID1 and ID2) and only ID1 is registered, all calls initiated to/from ID2 will be unsuccessful since ID2 has not been registered with the network.

The current registration procedures such as those specified by the 3^{rd} generation partnership project (3GPP) register public IDs for a user separately and independently, save those public IDs that belong to the same service profile. It has been proposed that all user identities of a particular subscriber shall be registered in a call controller entity. For example, release 5 (Rel5) version of a 3GPP standard document proposes that all those identities are registered in the same serving call state control function (S-CSCF) entity.

The S-CSCF entity is aware of the registration status only in the level of individual public IDs, and therefore it cannot know if a user has more than one registration and if the user is registered in more that one control entity.

As mentioned above, in some communication standards such as, for example, in the 3GPP Rel5 based communication systems, all public identities that belong to the same IP multimedia subsystem (IMS) subscriber have to be registered to the same controller entity. However, at the same time any registration, re-registration and de-registration proceeding are done on a one-by-one basis. Since the registration of individual public IDs is handled independently, it may happen that a user is registered to at least two S-CSCFs. This may not be allowed in all applications. For example, if the public ID such as public user identities (IMPUs) are registered to different S-CSCFs then it may be impossible to execute some services (e.g. forking).

As shown in FIG. 1, in the 3G the S-CSCF selection is typically done in the I-CSCF during registration. The I-CSCF, however, cannot know if the user is registered in any other S-CSCFs. Thus it is possible that the independent registrations of the same subscription are forwarded to different S-CSCFs based on the server capability information received by the I-CSCF from the home subscriber server (HSS).

A solution to the problem of multiple registrations is disclosed in an International application, publication No. WO 02/091785. This earlier patent application describes an embodiment wherein the I-CSCF is configured to decide whether newly registered identities are being addressed to a different S-CSCF than the one where earlier registration took place. If so, the old registrations are then moved to the new S-CSCF. Although the solution is believed to be viable, there is still a need for an alternative solution.

Furthermore, WO 02/091785 does not address the problem of having different types of identities and/or multiple private identities. For example, a subscription may have a plurality of private user identities (IMPI) and a plurality of public identities.

It shall be appreciated that, although the above discussed the registration proceedings and related problems with reference to an internet protocol (IP) based third generation (3G) communication system and session initiation protocol (SIP), similar disadvantages may be associated with other systems as well and thus the description is not limited to these examples.

### SUMMARY OF THE INVENTION

According to one embodiment of the invention, there is provided method in a communication system wherein a subscription is associated with a plurality of public and private identities, the method including storing in a user information storage information of the relations between the identities and of a control entity in which at least one of the identities is registered and allocating the control entity to a further registration based on the information stored in the user information storage.

According to another embodiment of the invention there is provided a communication system including a plurality of control entities and a user information storage, the user information storage being configured for storing information of the relations between public and private identities associated with users of the communication system and of a control entity in which at least one of the identities is registered, and means for allocating the call control entity to a further registration associated with a user based on the information stored in the user information storage.

According to still another embodiment of the invention there is provided a user information storage entity for a communication system, the user information storage entity including means for storing information of the relations between public and private identities associated with users of the communication system and of a control entity in which at least one of the identities is registered, and means for allocating the call control entity to a further registration associated with a user based on the information stored in the user information storage.

The embodiments of the invention may provide various advantages. All identities associated with a subscription may be registered to a single call state control function. The services may work in a normal manner and independently of the identity used by the subscription. In some embodiments it can be ensured that the private and public identities associated with a subscription are registered to the same servicing call control function. Some embodiments may enable provision of the same service for different identities in a similar manner.

### BRIEF DESCRIPTION OF THE DRAWINGS

For better understanding of the invention, reference will now be made by way of example to the accompanying drawings in which:

FIG. 1 shows information flows in an prior art arrangement;

FIG. 2 shows a part of a communication system wherein the invention can be embodied;

FIG. 3 shows information flows in accordance with an embodiment of the invention; and

FIG. 4 shows possible user identity relationships for a user.

### DETAILED DESCRIPTION OF THE PREFERRED EMBODIMENTS

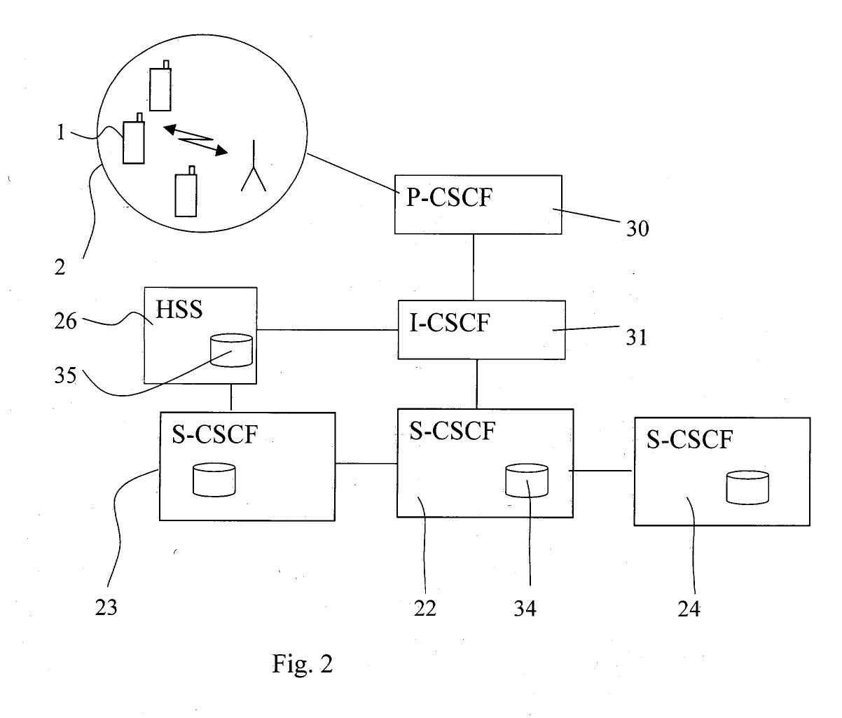

In the following, embodiments of the invention are described with reference to an exemplifying mobile communication system of FIG. 2 that is arranged in accordance with the 3G specifications. The mobile communication system is arranged to serve a plurality of mobile user equipment 1 via a wireless interface. The basic operational principles of mobile user equipment, that may also be referenced to as mobile stations, are known by the skilled person, and will thus not be explained in any more detail here.

A mobile communication system can typically be divided between a radio access network (RAN) and a core network (CN). A plurality of user equipment 1 of mobile users is served by a 3G radio access network (RAN) over a wireless interface. The user equipment is enabled to move relative to the access entity, and may thus be referred to by the term mobile station. It shall be appreciated that although FIG. 2 shows only one radio access network for clarity reasons, a typical communication network system includes a number of radio access networks. The 3G radio access network (RAN) is connected to appropriate core network entity or entities, such as to a serving general packet radio service support node (SGSN). The operation of a typical mobile communication network and the various entities thereof is known by one skilled in the art and will thus not be explained in more detail here.

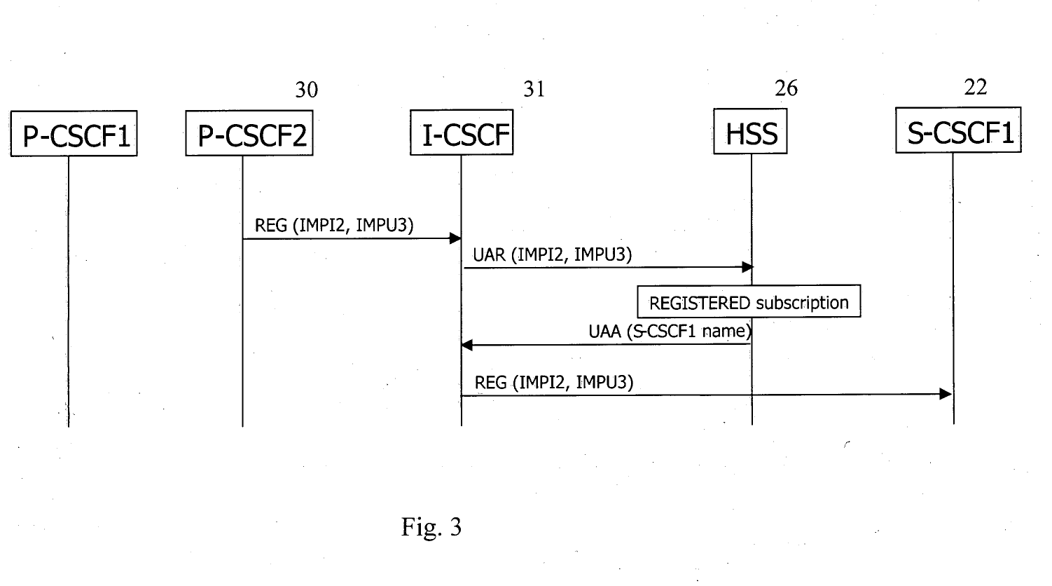

FIG. 2 shows also a plurality of call state control function entities (CSCFs) 22 to 24, 30 and 31, according to an embodiment of the invention. From these the call state control function entity 22 is the so called serving call state control function (S-CSCF) with which the user equipment 1 has at least one registration. That is, the user has registered at least one identity with the control entity 22. Thus the control entity 22 is currently serving the user equipment 1 and is in control of the status of the user equipment. Call state control function entities 23 and 24 could also provide similar functionality, should an identity of the user be registered with either of them. The functions the proxy CSCF 30 and the interrogating CSCF 31 will described below with reference also to the signaling flowchart of FIG. 3.

An example of a user information storage 26 is also shown. More particularly, the user information storage is shown to be provided by a home subscriber server (HSS). In accordance with this example of the invention the HSS is configured to store information of identities of the user and of a call control entity in which the user is registered. Information of possible relations between identities of different users may also be stored at the home subscriber server (HSS) 26. The home subscriber server (HSS) 26 may also store information such as the status of the registration identities (ID) (currently-registered-with a S-CSCF or currently-not-registered) and further similar information associated with the use of the communication system.

Control entity and status information may be saved in the storage means 35 of the user information storage 26 during registration. The stored information can be updated during re-registration and/or de-registration.

The home subscriber server (HSS) can be queried by the control entities, e.g. during registration and session set-up procedures. It shall be appreciated that the term “session” refers to any communication a user may have such as a call, data (e.g. web browsing) or multimedia communication and so on.

In a below described embodiment individual identity (ID) registrations for a subscription are synchronized in a 3GPP IMS (IP Multimedia Subsystem) domain by means of the HSS. In a preferred embodiment the HSS keeps a record of the relations between various identities associated with the subscription. The HSS also maintains information regarding identities that are registered to the S-CSCFs. In case of registration of a further identity related to an already existing registration, the same S-CSCF can be allocated for this registration by providing appropriate routing information such as the name and/or address of the S-CSCF.

Based on the information of the relations between various identities, the HSS may detect e.g. in the case of an initial registration of, for example, a public user identity (IMPU) whether any identities of the same user or subscription has already been registered. As shown in FIG. 3, in the case of an existing registration the HSS shall return the S-CSCF name in the response given for the user registration status query, instead of returning the server capabilities as is done in the prior art.

For example, such a response may be given for a user registration status query (UAR) that has been initiated by an I-CSCF. The I-CSCF may then forward the register message to the S-CSCF which name or address that was received in the response (UAA).

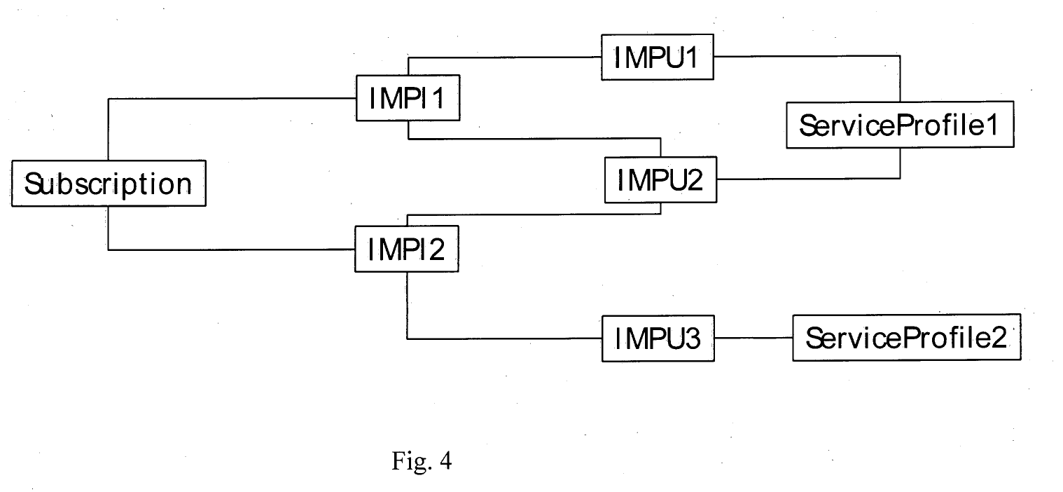

As explained a subscription may include a plurality of public and private identities. The are shown as IMPUs and IMPIs, respectively, in FIG. 4 which is an example of such Subscription-IMPI-IMPU-SP relations. The private identities IMPI1 and IMPI2 may be provided by two separate subscriber identity modules (SIM) or similar user identity modules associated with the user equipment. For example, in the 3GPP these identity modules are referenced as USIMs.

Since IMPIs can be stored on separate SIM cards and/or in separate user equipment, the HSS may not be able to forward registration from these user equipment to the same S-CSCF. However, the HSS can be provided with information regarding a common feature that refers to common services.

The HSS may track the relation between the IMPIs e.g. based on either at least one common public identity (IMPU) or common service profile (SP) or common subscription behind the private identities. Based on the relations the HSS can recognize that the same services should be provided.

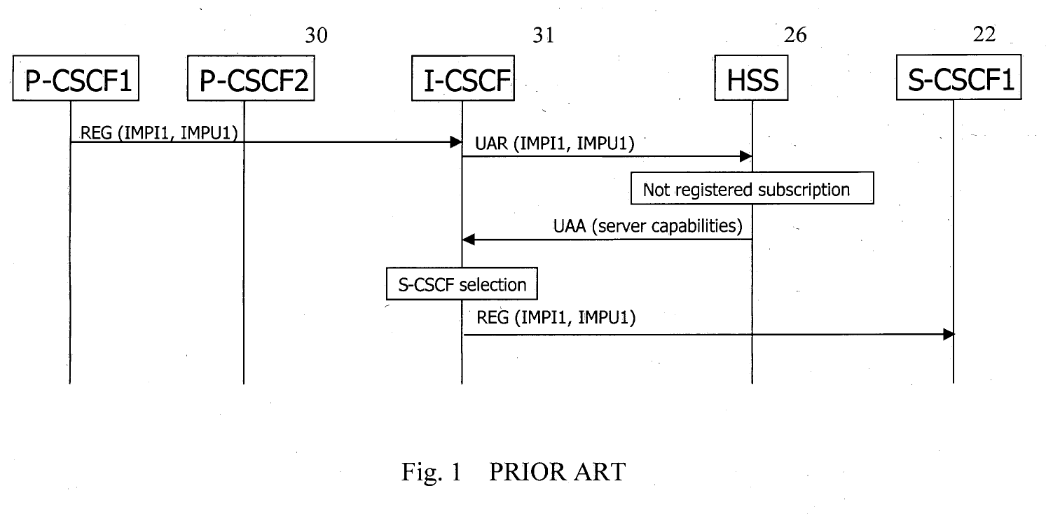

For example, if none of the public identities of the subscription is registered in any of the control entities 22 to 24, then the HSS 26 would return the service capabilities to the I-CSCF 31. The I-CSCF 31 may then make the allocation based on the service capabilities data received from the HSS 26 as shown in FIG. 1. Upon receiving the query, the HSS 26 checks if the subscription already has a registered public identity. It is possible that the private identity (e.g. a user associated with the subscription) associated with the public identity to be registered does not have any registered public identities while the subscription already has at least one such associated registration. In this case the HSS 26 may send the S-CSCF name to the I-CSCF 31. In other words, the HSS 26 makes the allocation instead of the I-CSCF 31 based on the detection that the identity has a related identity, the relation being through the subscription.

In accordance with an embodiment the HSS 26 is able to recognize that different private identities (IMPIs) having common public identities (IMPUs) belong to a single subscriber. Information regarding the relations between the identities and the service profiles (SPs) may also be analyzed. Private identities may be used, for example, for bundling several public identities of a given subscription or a number of user equipment together.

In the example of FIG. 4 the two public identities IMPU1 and IMPU3 are totally independent from each other. However, as shown in FIG. 4, the two public identities are having a relation via two private identities IMPI1 and IMPI2. The two private identities are also each having a relationship with a third public identity IMPU2. Thus in this example the registration of the two independent public identities in the same S-CSCF can be made due to the common IMPU2.

The build-up of the relationship chain may be done regardless of the registration status of the common private identity.

It may happen that the common IMPU is not even registered but the HSS allocates the same S-CSCF to both IMPI1 and IMP12 in instances where there are two users or one user with two terminals. Nevertheless, both of these users would like to access a common service. The HSS stores information regarding the relations between the identities and is thus able to determine the relation between the two separate IMPIs.

Upon the recognition of the relationships between the identities the HSS may only need to send to the I-CSCF the name or other information enabling routing to the already used S-CSCF instead of sending information regarding server capabilities. In such a case, the new identities will be registered at the same S-CSCF instead of where the existing registrations are.

More particularly, in FIG. 3 a user equipment may have requested for registration e.g. by sending a SIP REGISTER message to a proxy server entity 30. The registration request is forwarded from the proxy 30 to an interrogating server entity 31. An appropriate query procedure may then be accomplished between the interrogating server entity 31 and the subscriber information database 35 of the home subscriber server 26.

During the query procedure the HSS 26 may recognize based on the information stored thereof that the identity relates to some other already registered public and/or private identities associated with a subscription. The stored information may describe the relationships between the various identities. An example of various relations that two private identities may have is shown in FIG. 4. Based on this information the HSS may e.g. recognize that at least one other public identity is registered with the control entity 22 (S-CSCF 1). Thus the HSS 26 may return as a response to the query the name or address or other routing information of the S-CSCF1 22 to the I-CSCF 31. The interrogating server 31 may then request for registration from the controller entity 22 based on the returned routing information.

This mechanism may be used to ensure that registrations of all public and/or private IDs utilizing the same services take place at the same controller entity. The proposed mechanism may ensure that all IDs belonging to the same subscription or same service profile are registered to the same S-CSCF. Registration at the same servicing control entity enables provision of the same services for a subscriber or a number of subscribers This can be realized by storing the information about the relationships between the identities in a user information storage and by responding to control entity queries by the name or address of the servicing control entity instead of server capabilities information.

It should be appreciated that while embodiments of the invention have been described in relation to user equipment such as mobile stations, embodiments of the invention are applicable to any other suitable type of users.

The embodiments of the invention were discussed with reference to call state control function entities. Embodiments of the invention can be applicable to other network elements where applicable.

The embodiment of the invention has been described in the context of the Universal Mobile Telecommunication System (UMTS) 3G system and session initiation protocol (SIP). This invention is also applicable to any other communication systems and protocols. Examples of other systems, without limiting to these, include the General Packet Radio Service (GPRS), the Enhanced Data rate for GSM Evolution (EDGE) mobile data network, other third generation (3G) telecommunication systems such as the i-phone or IMT-2000 (International Mobile Telecommunications) and the Terrestrial Trunked Radio (TETRA) system.

It is also noted herein that while the above describes exemplifying embodiments of the invention, there are several variations and modifications which may be made to the disclosed solution without departing from the scope of the invention as defined in the appended claims.

1. A method in a communication system wherein a subscription is associated with a plurality of public and private identities, the method comprising:
storing in a user information storage information of relations between the plurality of public and private identities and of a control entity in which at least one of the identities is registered; and
allocating the control entity to a further registration based on the information stored in the user information storage.

2. A method as claimed in claim 1, comprising the further steps of:
querying by a further control entity for a registration status of a user from the user information storage; and
responding to the query by returning routing information which enables routing of a registration request to the control entity.

3. A method as claimed in claim 2, wherein the querying step comprises querying by the further control entity which comprises an interrogating call state control function and the the control entity comprises a servicing call state control function.

4. A method as claimed in claim 2, wherein the responding step comprises responding to the query by returning the routing information which enables routing to the control entity and comprises a name of the control entity.

5. A method as claimed in claim 2, wherein the responding step comprises responding to the query by returning the routing information which enables routing to the control entity and comprises an address of the control entity.

6. A method as claimed in claim 1, further comprising selecting at the user information storage the control entity to be allocated for the further registration.

7. A method as claimed in claim 1, further comprising the step of recognizing at the user information storage that the user has an existing registration.

8. A method as claimed in claim 1, further comprising the step of recognizing at the user information storage that different private identities associated with a common public identity are associated with a subscription.

9. A method as claimed in claim 1, further comprising the step of recognizing at the user information storage that different private identities associate with a common service profile.

10. A method as claimed in claim 1, further comprising the step of recognizing at the user information storage that different private identities associate with a common subscription.

11. A method as claimed in claim 1, wherein the storing step comprises storing in the user information storage which comprises a home subscriber server.

12. A communication system comprising:
a plurality of control entities;
a user information storage being configured for storing information of relations between public and private identities associated with users of a communication system and of a control entity in which at least one of the public and privates identities is registered; and
allocating means for allocating a call control entity to a further registration associated with a user based on the information stored in the user information storage.

13. A user information storage entity for a communication system, the user information storage entity comprising:
storing means for storing information of relations between public and private identities associated with users of a communication system and of a control entity in which at least one of the public and private identities is registered; and
allocating means for allocating the call control entity to a further registration associated with a user based on the information stored in the user information storage.

14. An entity as claimed in claim 13, further comprising:
querying means for querying by a further control entity for a registration status of a user from the user information storage; and
responding means for responding to a query by returning routing information which enables routing of a registration request to the control entity.

15. An entity as claimed in claim 14, wherein the querying means queries by using the further control entity which comprises an interrogating call state control function and the the control entity comprises a servicing call state control function.

16. An entity as claimed in claim 14, wherein the responding means responds to the query by returning the routing information which enables routing to the control entity and comprises a name of the control entity.

17. An entity as claimed in claim 14, wherein the responding means responds to the query by returning the routing information which enables routing to the control entity and comprises an address of the control entity.

18. An entity as claimed in claim 13, further comprising selecting means for selecting at the user information storage the control entity to be allocated for the further registration.

19. An entity as claimed in claim 13, further comprising recognizing means for recognizing at the user information storage that the user has an existing registration.

20. An entity as claimed in claim 13, further comprising recognizing means for recognizing at the user information storage that different private identities associated with a common public identity are associated with a subscription.

21. An entity as claimed in claim 13, further comprising recognizing means for recognizing at the user information storage that different private identities associate with a common service profile.

22. An entity as claimed in claim 13, further comprising recognizing means for recognizing at the user information storage that different private identities associate with a common subscription.

23. An entity as claimed in claim 13, wherein the storing means stores the information in a user information storage which comprises a home subscriber server.
